(19) United States
(12) Patent Application Publication
(10) Pub. No.: US 2006/0098961 A1
(43) Pub. Date: May 11, 2006

(54) Baby warmer

(76) Inventors: Jess Seutter, Sherwood Park (CA); Christal Gayle Seutter, Sherwood Park (CA)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/984,395

(22) Filed: Nov. 8, 2004

(51) Int. Cl. F26B 3/02; F24H 3/00

(52) U.S. Cl. 392/383; 392/380; 392/381

(57) ABSTRACT

An electric heater and a fan are both supported within a cylindrical case for blowing warmed air from one end of the case. The case is supported at a distal end of a flexible strut enabling selective positioning of the one end of the case for directing the warmed air in a preferred direction. A base is rotationally engaged with a proximal end of the flexible strut. The base provides a means for supporting the flexible strut and the case in a selected orientation. A lamp is fixed to the case in a position for directing illumination from the lamp lateral to the case. A first power switch is connected for energizing the electric heater and fan, while a second power switch is connected for energizing the lamp. The two power switches are functional for independent operation.

### RELATED APPLICATIONS

none

### INCORPORATION BY REFERENCE

Applicant hereby incorporates herein by reference, the U.S. patents and U.S. patent applications, if any, referred to in the Description of Related Art section of this application as filed.

### BACKGROUND OF THE INVENTION

1. Field of the Invention

This invention relates generally to heaters and lamps and more particularly to a combination heater and lamp particularly adapted for use with a baby.

2. Description of Related Art

The following art defines the present state of this field and each disclosure is hereby incorporated herein by reference:

Lawlor, U.S. D326148 is an ornamental design for a fan for infants and children.

Rodrigue, Jr., U.S. D328949 is an ornamental design for a baby stroller fan.

Crosby, U.S. D404733 is an ornamental design for a baby calming device.

Sabo et al., U.S. Pat. No. 4,206,556 describes a device used for the application of fingernail polish and the like comprises a housing, a finger insert for positioning a finger on the housing, lighting means in the housing for providing direct illuminatin on the finger insert, a motorized fan for drying a polished fingernail, means for actuating the lighting means and the motorized fan, an air inlet in the housing for supplying air to the fan and an air outlet in the housing for directing air blown by the fan at the finger insert so that when a fingernail is polished it is quickly and easily dried without moving the finger to a new location.

Michaels et al., U.S. Pat. No. 5,103,577 relates to a common annoyance for many people which is the sensed change in temperature after disrobing or upon exiting the bathtub or shower stall area. The body heater/drier utilizes a unique means by which it disperses warm air to the many areas of the user. Air is drawn into the base assembly of the apparatus, heated and forced to flow into the tubing sections connected in series above. The air within increases in pressure since the total volumetric flow of air induced within the apparatus is greater than total volumetric flow of air, which is possible through the limited total cumulative area of all the output openings. The resultant pressure causes the air to flow out of the apparatus in various directions and in varying volumes directly dependent upon the particular inclination in size and shape of each various output opening through which air flows. The output openings act jets to control air dispersal. The body heater/drier is designed to be space efficient, light-weight, self-supporting, easily assembled or disassembled, and easily transportable by most any adult person without need for assistance or tools. This design enables the apparatus to utilize the equivalent heating element and fan/blower assembly power as that of a common hand held hair dryer.

Chimera, U.S. Pat. No. 5,394,620 describes a hand held, portable body dryer for the entire body that is disclosed as including a hollow tube carrying a hollow hand grip in which a battery is disposed; a fan and a heater are disposed in the tube with rheostatic controls therefor on the exterior of the tube with indications for off, low and high positions, and with a reverse fan switch for cleaning the tube. A plurality of attachments for the dryer function as outlet nozzles for assuring entire body coverage.

Carter, U.S. Pat. No. 5,725,356 describes a portable fan for use on a child's stroller. The fan has a housing, an electric motor in the housing powered by a source such as a battery so that the motor does not require any physical connection to a fixed location, a mechanism for moving air including a shaft connected to the motor, a hub on the shaft and a plurality of blades, made of a resiliently flexible material, projecting radially outwardly from the hub, a shroud having an animal face depicted thereon connected to the housing and substantially enclosing said air moving mechanism, a clamp for releasably clamping the fan onto the stroller being shaped in the form of an animal foot and a bendable support interconnecting the housing and the fan.

Steele et al., U.S. Pat. No. 5,816,910 describes a portable apparatus for soothing infants to enable them to fall asleep that utilizes a portable housing having a cylindrically-shaped intake and exhaust opening coupled by a hollow cylindrical tube into which is located a miniature motor disposed proximate the intake opening with fan blades affixed on the rotating motor shaft that provides an air flow over a plurality of flexible members disposed proximate the exhaust opening. A control arrangement, coupled to a battery power source, is disposed within the housing for controlling the amount of forced air flowing out of the exhaust opening so that the tone or the sounds emanating from the apparatus can be controlled.

Johnson, U.S. Pat. No. 5,876,178 describes A materials handling apparatus that is securable to a materials handling vehicle so as to permit an operator to position an arm carrying a pusher element over a stack of large heavy packages and to bring the pusher element to bear on the top package on the stack so as to push the package from the stack onto a carrier such as a pallet.

Rura, U.S. Pat. No. 6,027,137 describes a baby carriage with cooling mechanisms including a baby carriage that has a container for receiving a baby. The carriage also has four wheels secured there below and a handle for use by a childcare provider for pushing the carriage and baby. The carriage also has a canopy positioned over one end of the carrier for shielding the face of an infant therewithin from the sun. The carriage also has a rectangular housing secured within a similarly sized rectangular aperture in the canopy. The housing includes an upwardly extending rectilinear support with a lid slidably coupled to the support to selectively conceal and expose the interior of the housing. The housing has an upper end and a lower end. A fan is provided with a fan motor and a drive shaft vertically disposed and secured within the housing adjacent to the lower end with rotatable fan blades secured to the drive shaft with a source of potential for selectively energizing the fan motor and fan.

Our prior art search with abstracts described above teaches: a nail polish machine, a body heater-dryer, a fan for infants and children, a baby stroller fan design, a body dryer, a portable fan device, an infant soother apparatus, a portable hand dryer, a baby carriage with cooling mechanisms, and a baby calming sound playback device design. Thus, the prior art shows that it is well known to provide a heating device for babies and a lighting device that may be used for babies. However, the prior art does not appear to teach the type of heat and light producing device of the present invention. Further, the prior art fails to teach such a device that may be used in the manner described herein, especially with the clip-on and wall mounting features described. The present invention fulfills these needs and provides further related advantages as described in the following summary.

### SUMMARY OF THE INVENTION

The present invention teaches certain benefits in construction and use which give rise to the objectives described below.

The present invention, in one embodiment, is a baby product designed specifically for soothing infants during diaper changes, after baths, or any time baby is fussy and unhappy. It is a warmer that helps to prevent diaper rash by ensuring that the baby's bottom area is dry before a new diaper is put on. It elicits co-operation and compliance from the baby as he/she enjoys the process rather than fighting it.

The product is an electrical device that emits a gentle, warm stream of air as well as a soft glow of light. It provides a hands-free method of directing warm air at the baby's bottom during diaper changes. It can be likened to a blow dryer that is mounted to a flexible arm in the same fashion as the well known goose-neck lamp. The heater and fan of the product are encased in a heat-resistant, soft plastic cylindrical head with a filtered vent at the back and a plastic safety grate at the front. The design is just like a typical small-sized hair dryer, however, the heat level is much lower and the fan blows no stronger than the lowest setting of most hair dryers. Switches are located conveniently for turning heat and illumination on and off.

This invention features a low watt light with a plastic cover. This serves as a work light for nighttime changes or to check baby without rousing her with a bright light. The light is located along the underside of the head in such a fashion that the light is aimed in the same direction as the flow of warm air. The light switch is just below the light where the head of the product connects with the gooseneck arm. An electrical safety fault is incorporated in case of exposure to water. This is important due to the unexpected and ill-directed streams that so often surprise parents of baby boys.

In one version, a clamp is located at the bottom end of the gooseneck arm so that it can be attached directly to a table or clamped onto a weighted, non-slip base or a wall-mounted bracket. The gooseneck is flexible enough to direct the head of the blower as desired as well as having a swivel joint at the base of the neck where the clamp is attached.

The tabletop base is weighted and has a rubberized bottom to prevent it from slipping on the surface it is rested on. The apparatus can be attached firmly to this base by clamping it to a curved component on the top of the base.

A primary objective of the present invention is to provide an apparatus and method of use of such apparatus that yields advantages not taught by the prior art.

Another objective of the invention is to provide a combination of directed soft and warm air flow with a low level light source.

A further objective of the invention is to provide a highly adjustable source of such air and light.

A still further objective of the invention is to provide adaptable mounting alternatives.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

The accompanying drawings illustrate at least one of the best mode embodiments of the present invention. In such drawings:

FIG. 1 is a perspective view of one embodiment of the invention;

FIGS. 2-4 are perspective views thereof showing various ways of mounting a further embodiment.

### DETAILED DESCRIPTION OF THE INVENTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

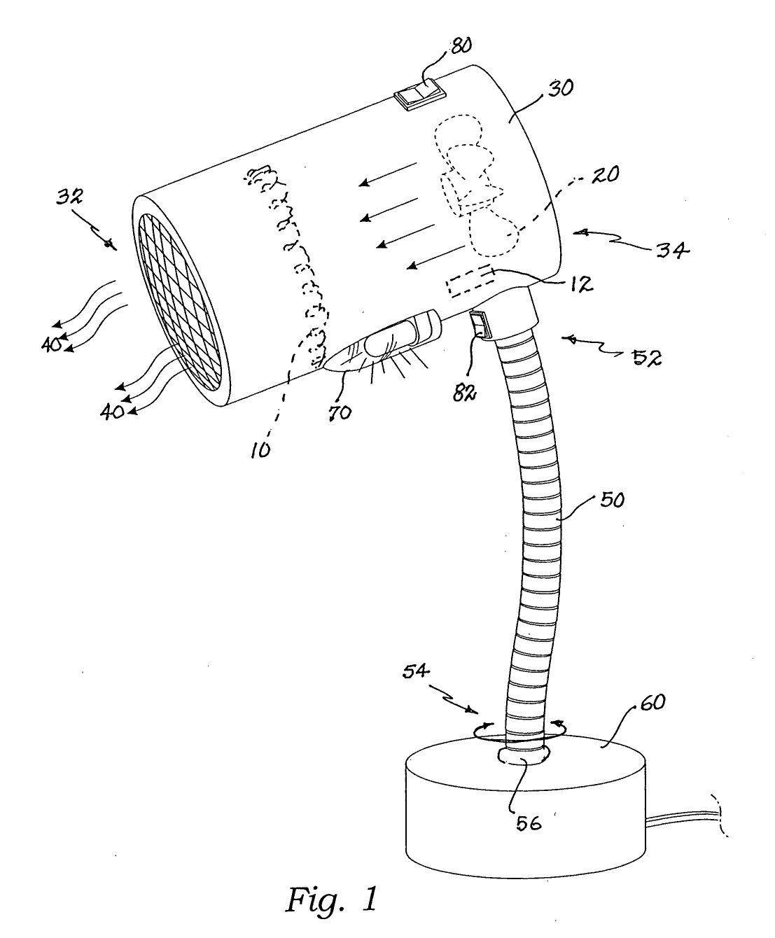

In one embodiment of the present invention an electric heater 10, such as an electric coil, and a fan 20 are both supported within a cylindrical case 30 for blowing warmed air 40 from one end 32 of the case 30. Room air is drawn in at the opposing end 34 of the case 30, preferably through a filter medium such as is well known in the art. The case 30 is supported at distal end 52 of a flexible strut 50, such as might be found on a goose neck lamp, enabling selective positioning of the one end 32 of the case 30 for directing the warmed air 40 in a preferred direction. A base 60 is engaged with a proximal end 54 of the flexible strut 50, the base 60 supporting the flexible strut 50 and the case 30 in a selected orientation; as shown in FIGS. 1-4. Preferably, a swivel link 56 engages the proximal end 54 of the flexible strut 50 with the base 60 so that the entire strut 50 is able to rotate relative to the base 60, and such a swivel link 56 is well known in the art. A lamp 70 is fixed to the case 30 in a position for directing illumination from the lamp 70 laterally and forwardly from the case 30. A first power switch 80 is incorporated for energizing the electric heater 10 and fan 20, while a second power switch 82 is incorporated for energizing the lamp 70. An over-current sensor 12 is incorporated into the circuit of the heater and fan 10, 20 for preventing high current flow in case of a short circuit due to wetness of the apparatus.

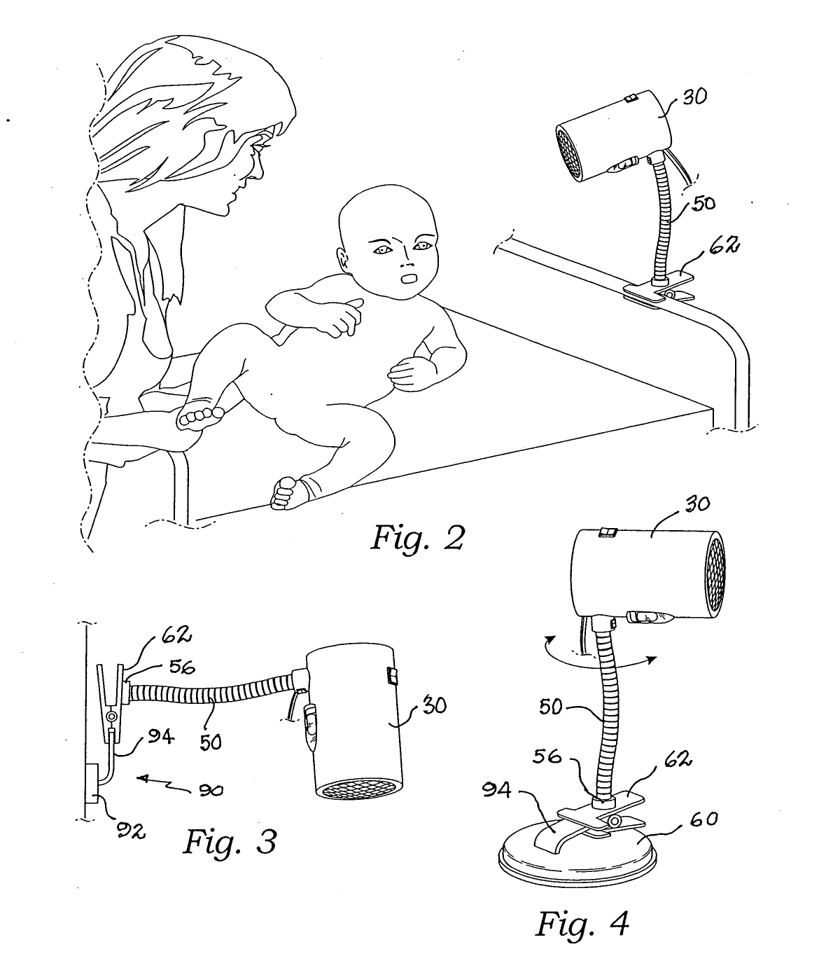

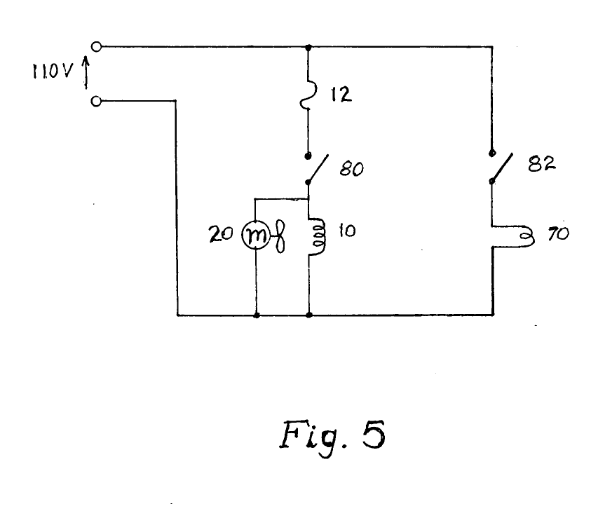

Preferably, the base 60 is a heavily weighted member, as shown in FIGS. 1 and 4, of such mass as to stabilize the apparatus when in an upright attitude. Alternately, as shown in FIGS. 2 and 3, a spring clip 62 is provided with sufficient clamping strength as to hold the apparatus in an attitude extending horizontally from the spring clip 62, as shown in FIG. 3.

Preferably, a wall fixture 90 with a wall mounting base 92 has an outwardly extending finger 94 adapted for being received within the spring clip 62 for holding the apparatus for extending outwardly from a wall, again as shown in FIG. 3.

The base 60 may be modified as shown in FIG. 4 to provide the finger 94 for supporting the apparatus with the spring clip 62.

The apparatus is adapted, for low heat output, low air flow and low light illumination level relative to conventional apparatus in use for similar purposes.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. An apparatus comprising: an electric heater and a fan both supported within a cylindrical case for blowing warmed air from a one end of the case, the fan adapted for relatively low air flow, the heater adapted for relatively low heat output; the case supported at a distal end of a flexible strut enabling selective positioning of the one end of the case for directing the warmed air in a preferred direction; a base engaged with a proximal end of the flexible strut, the base providing a means for supporting the flexible strut and the case in a selected orientation; a lamp fixed to the case in a position adjacent to the distal end of the flexible strut and away from the one end of the case for directing illumination from the lamp lateral to the case and primarily downwardly toward the base, the lamp adapted for relatively low illumination; a first power switch connected for energizing the electric heater; and a second power switch connected for energizing the lamp, the first and the second power switches functional for independent operation.

2. The apparatus of claim 1 wherein the base is a weighted member of such mass as to stabilize the apparatus in an upright attitude.

3. The apparatus of claim 1 wherein the base is a spring clip of such clamping strength as to hold the apparatus in a horizontal attitude extending from the spring clip.

4. The apparatus of claim 3 further comprising a wall fixture having a wall mounting base and an outwardly extending finger, the finger adapted for being received within the spring clip for holding the apparatus extending outwardly from a wall.

5. The apparatus of claim 1 wherein the flexible strut is a goose neck structure.

6. The apparatus of claim 1 further comprising a swivel joint connecting the flexible strut with the base.

7. The apparatus of claim 1 further comprising an over-current fuse for preventing short circuits.
